(19) United States
(12) Patent Application Publication
(10) Pub. No.: US 2023/0154710 A1
(43) Pub. Date: May 18, 2023

(54) HERMETICALLY SEALED ELECTROMAGNETIC CONTACTOR

(71) Applicant: FUJI ELECTRIC FA COMPONENTS & SYSTEMS CO., LTD., Konosu-shi (JP)

(72) Inventors: Takashi TSUTSUMI, Kounosu-city (JP); Koujun KONISHI, Kounosu-city (JP); Hideo ADACHI, Fukaya-city (JP)

(73) Assignee: FUJI ELECTRIC FA COMPONENTS & SYSTEMS CO., LTD., Konosu-shi (JP)

(21) Appl. No.: 18/091,785

(22) Filed: Dec. 30, 2022

Related U.S. Application Data
(63) Continuation of application No. PCT/JP2021/044677, filed on Dec. 6, 2021.

(30) Foreign Application Priority Data
Jan. 22, 2021 (JP) 2021-008371

(51) Int. Cl. H01H 50/38; H01H 50/02

(52) U.S. Cl. CPC H01H 50/38; H01H 50/023; H01H 2050/025

(57) ABSTRACT

A hermetically sealed electromagnetic contactor includes a pair of fixed contact pieces having fixed contacts, a movable contact piece having a pair of movable contacts and capable of coming into contact with and being separated from the fixed contacts of the pair of fixed contact pieces, an electromagnet unit configured to drive the movable contact piece, a hermetically sealed container configured to house the pair of fixed contact pieces, the movable contact piece, and the electromagnet unit in the same space in a hermetically sealed manner and being filled with arc-extinguishing gas, and two pairs of arc-extinguishing permanent magnets arranged inside the hermetically sealed container and configured to stretch arcs generated between the fixed contacts of the pair of fixed contact pieces and the pair of movable contacts of the movable contact piece.

### CROSS-REFERENCE TO RELATED APPLICATION

This application is a continuation application filed under 35 U.S.C. § 111(a) of International Patent Application No. PCT/JP2021/044677, filed on Dec. 6, 2021, the contents of which are incorporated herein by reference.

### TECHNICAL FIELD

The present invention relates to a hermetically sealed electromagnetic contactor in which fixed contact pieces and a movable contact piece are arranged in a hermetically sealed container filled with arc-extinguishing gas.

### BACKGROUND ART

As a hermetically sealed electromagnetic contactor, for example, a device described in PTL 1 has been known.

A hermetically sealed electromagnetic contactor in PTL 1 includes a pair of fixed contact pieces having fixed contacts, a movable contact piece having a pair of movable contacts capable of coming into contact with and being separated from the fixed contacts of the pair of fixed contact pieces, a hermetically sealed container being filled with arc-extinguishing gas thereinside and housing the pair of fixed contact pieces and the movable contact piece, an electromagnet device coupled to the movable contact piece via a drive shaft, and a pair of arc-extinguishing permanent magnets arranged along both sides in the width direction of the movable contact piece and having facing magnetic pole surfaces, which face each other, magnetized to the same polarity.

The hermetically sealed electromagnetic contactor in PTL 1 is configured such that, when arcs are generated when the movable contacts of the movable contact piece are separated from the fixed contacts of the pair of fixed contact pieces, not only are the arcs on which Lorentz force, generated in accordance with Fleming's left hand rule, is exerted by magnetic flux of the arc-extinguishing permanent magnets crossing the arcs stretched, but also the arcs are cooled by arc-extinguishing gas in the housing case and the arcs are thereby extinguished.

### CITATION LIST

### Patent Literature

PTL 1: WO 2011/115052 A

### SUMMARY OF INVENTION

### Technical Problem

Regarding the device in PTL 1, when the internal volume of the hermetically sealed container in which the pair of fixed contact pieces and the movable contact piece are housed is small, pressure and temperature inside the hermetically sealed container increase when arcs are generated, which influences breaking performance.

Although increasing the internal volume of the hermetically sealed container in order to suppress increase in internal pressure and temperature when arcs are generated can therefore be considered, the device in PTL 1 has the pair of arc-extinguishing permanent magnets arranged outside the hermetically sealed container, and, when the internal volume of the hermetically sealed container is increased, there is a possibility that distance between the arc-extinguishing permanent magnets and arc generation positions (positions of the fixed contacts and the movable contacts) becomes long and arc stretching effect by Lorentz force becomes weak.

As described above, regarding the device in PTL 1, there is a problem in that increasing the internal volume of the hermetically sealed container and decreasing the distance between the arc-extinguishing permanent magnets and the arc generation positions contradict each other and breaking performance thus cannot be improved.

Accordingly, the present invention has been made in consideration of the above-described situation, and an object of the present invention is to provide a hermetically sealed electromagnetic contactor that enables breaking performance to be improved by increasing internal volume of a hermetically sealed container and arranging arc-extinguishing permanent magnets close to arc generation positions.

### Solution to Problem

In order to achieve the above-described object, according to one aspect of the present invention, there is provided a hermetically sealed electromagnetic contactor including a pair of fixed contact pieces having fixed contacts, a movable contact piece having a pair of movable contacts capable of coming into contact with and being separated from the fixed contacts of the pair of fixed contact pieces, an electromagnet unit configured to drive the movable contact piece, a hermetically sealed container configured to house the pair of fixed contact pieces, the movable contact piece, and the electromagnet unit in the same space in a hermetically sealed manner and being filled with arc-extinguishing gas, and at least a pair of arc-extinguishing permanent magnets arranged inside the hermetically sealed container and configured to stretch arcs generated between the fixed contacts of the pair of fixed contact pieces and the pair of movable contacts of the movable contact piece.

### Advantageous Effects of Invention

A hermetically sealed electromagnetic contactor of the present invention enables breaking performance to be improved by increasing internal volume of a hermetically sealed container and arranging arc-extinguishing permanent magnets close to arc generation positions.

### BRIEF DESCRIPTION OF DRAWINGS

FIG. 1 is a perspective view illustrative of an external appearance of a hermetically sealed electromagnetic contactor of an embodiment according to the present invention;

FIG. 2 is a diagram illustrative of a cross section of a hermetically sealed container constituting the hermetically sealed electromagnetic contactor of the embodiment;

FIG. 3 is a cross section taken along the long-length direction of the hermetically sealed electromagnetic contactor of the embodiment;

FIG. 4 is a cross section taken along the short-length direction of the hermetically sealed electromagnetic contactor of the embodiment;

FIG. 5 is a cross-sectional view taken along the line V-V and viewed from the arrows in FIG. 3; and

FIG. 6 is a diagram illustrative of a structure of magnet holders, permanent magnet yokes, and arc-extinguishing permanent magnets mounted on the magnet holders, which are arranged inside a housing case.

### DESCRIPTION OF EMBODIMENTS

Next, an embodiment according to the present invention will be described with reference to the drawings. In the following drawing description, the same or similar reference signs are assigned to the same or similar constituent components. However, it should be noted that the drawings are schematic and relations between thicknesses and planar dimensions, ratios among thicknesses of respective layers, and the like are different from actual ones. Therefore, specific thicknesses and dimensions should be determined in consideration of the following description. It should also be noted that the drawings include portions having different dimensional relationships and ratios from one another among the drawings.

In addition, the embodiments, which will be described below, indicate a device and a method to embody the technical idea of the present invention by way of example, and the technical idea of the present invention does not limit the materials, shapes, structures, arrangements, and the like of the constituent components to those described below. The technical idea of the present invention can be subjected to a variety of alterations within the technical scope prescribed by the claims described in CLAIMS.

Note that terms indicating directions, such as “upper”, “lower”, “left”, “right”, “bottom”, “front”, “rear”, “long-length direction”, and “short-length direction”, that are referred to in the following description are used referring to the directions in the accompanying drawings.

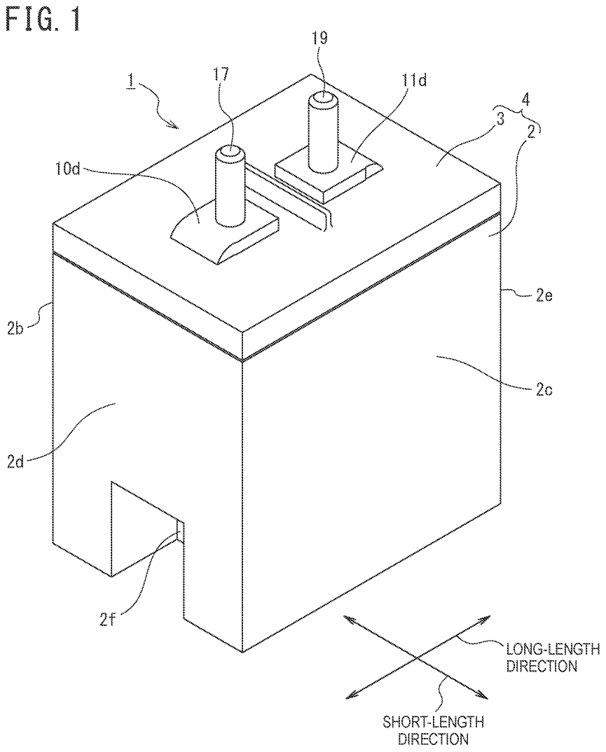

An electromagnetic contactor as a hermetically sealed electromagnetic contactor of an embodiment according to the present invention will be described with reference to FIGS. 1 to 6.

An electromagnetic contactor 1 of the present embodiment, illustrated in FIG. 1, includes a housing case 4 composed of a bottomed box-shaped insulating box 2 that is formed of synthetic resin, such as phenol, polyamide, and polybutylene terephthalate, and an insulating substrate 3 that closes an upper opening of the insulating box 2 and is formed of synthetic resin. The insulating box 2 and the insulating substrate 3 are bonded by, for example, epoxy resin-based adhesive.

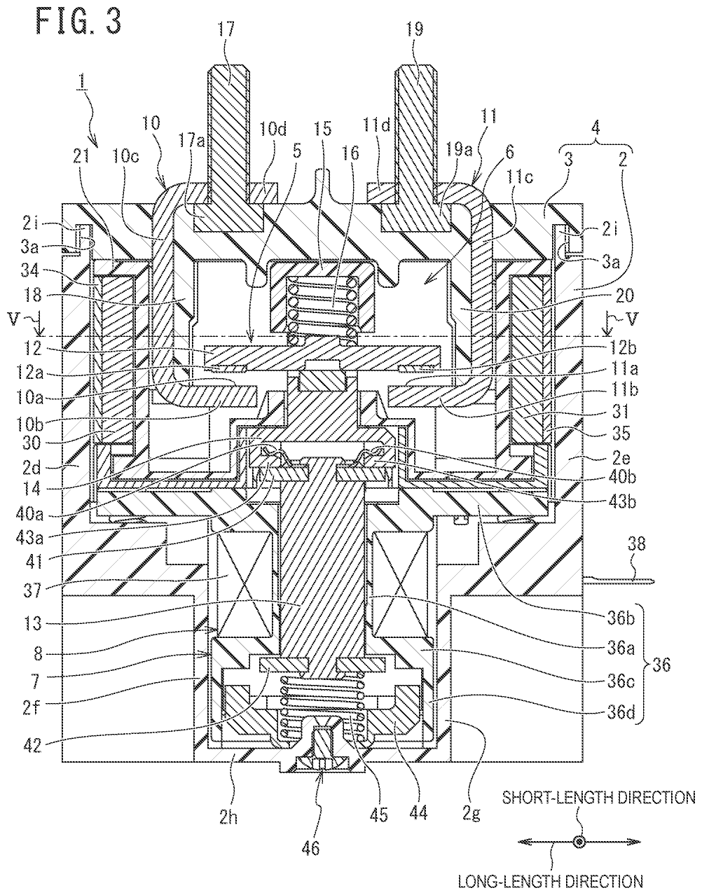

The insulating box 2 includes first and second sidewalls 2b and 2c that are opposed to each other in the short-length direction, third and fourth sidewalls 2d and 2e that are opposed to each other in the long-length direction, fifth and sixth sidewalls 2f and 2g that are opposed to each other at a shorter distance than a distance at which the third and fourth sidewalls 2d and 2e are opposed to each other at lower positions of the third and fourth sidewalls 2d and 2e (see FIG. 3), and a bottom wall 2h that extends in the right and left direction at the lower edges of the first and second sidewalls 2b and 2c and the fifth and sixth sidewalls 2f and 2g (see FIG. 3).

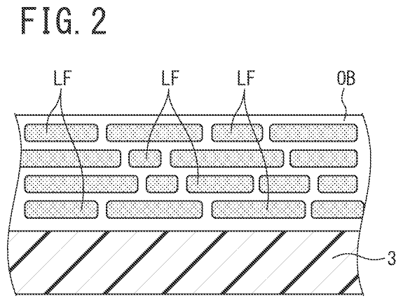

FIG. 2 illustrates a portion of the insulating substrate 3, which constitutes the housing case 4, and a surface of the insulating substrate 3 that comes into contact with the outside air is coated with laminated films LF having a predetermined thickness.

The laminated films LF are specifically laminated films of clay crystals, and exchanging interlayer ions in purified smectite and joining the laminated films with a water-soluble organic binder OB, such as PVA and water-soluble nylon, causes the laminated films to exhibit labyrinth effect and thereby prevent permeation of gas molecules, such as hydrogen and nitrogen. The laminated films LF are stacked in the thickness direction, and the thickness thereof is, for example, 2 μm. The laminated films LF are applied by a spray method in which coating liquid is formed into mist and applied to the insulating substrate 3, and are completed by being burned at a temperature at which interlayer ions are incorporated into clay crystals, for example, a temperature greater than or equal to 150 degrees.

Note that surfaces of the insulating box 2 that come into contact with the outside air, that is, all surfaces of the insulating box 2, including boundary portion between the insulating box 2 and the insulating substrate 3, that come into contact with the outside air, are also coated with laminated films LF having a predetermined thickness.

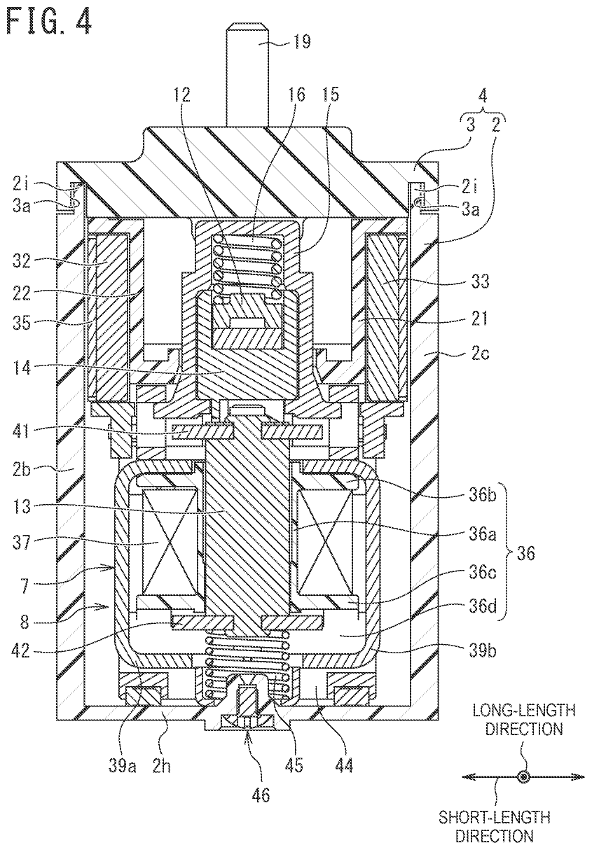

As illustrated in FIG. 3, connection protruding lines 2i are formed in the short-length direction on the upper edges of the third and fourth sidewalls 2d and 2e of the insulating box 2, and, as illustrated in FIG. 4, connection protruding lines 2i are also formed in the long-length direction on the upper edges of the first and second sidewalls 2b and 2c of the insulating box 2. Because of this configuration, on the upper edges of the first to fourth sidewalls 2b to 2e, which constitute the insulating box 2, the connection protruding lines 2i are continuously formed in a rectangular frame shape.

In addition, as illustrated in FIGS. 3 and 4, connection recessed lines 3a are continuously formed in a rectangular frame shape on the under surface of the insulating substrate 3, and, when the insulating substrate 3 is arranged in such a way as to close an upper space of the insulating box 2, the rectangular frame-shaped connection protruding lines 2i of the insulating box 2 enter into the inside of the connection recessed lines 3a of the insulating substrate 3. Injecting adhesive for resin onto the connection protruding lines 2i and into the connection recessed lines 3a and subsequently inserting the connection protruding lines 2i of the insulating box 2 into the connection recessed lines 3a of the insulating substrate 3 cause airtightness of a contact housing portion 6 and an electromagnet housing portion 8, which are internal spaces of the housing case 4, to be maintained.

As illustrated in FIGS. 3 and 4, an internal space on the upper side of the housing case 4 that is enclosed by the insulating substrate 3, which closes the upper opening of the insulating box 2, and the first to fourth sidewalls 2b to 2e is defined as the contact housing portion 6 that houses a contact mechanism 5, and an internal space on the lower side of the housing case 4 that is enclosed by the first and second sidewalls 2b and 2c, the fifth and sixth sidewalls 2f and 2g, and the bottom wall 2h is defined as the electromagnet housing portion 8 that communicates with the contact housing portion 6 and houses an electromagnet unit 7.

The contact mechanism 5, which is housed in the contact housing portion 6 of the housing case 4, includes a pair of fixed contact pieces 10 and 11 (hereinafter, referred to as a first fixed contact piece 10 and a second fixed contact piece 11) that are fixed to the insulating substrate 3 and a movable contact piece 12 that includes first and second movable contacts 12a and 12b, which face first and second fixed contacts 10a and 11a formed on the first and second fixed contact pieces 10 and 11, respectively, and that extends in the long-length direction, as illustrated in FIG. 3.

The movable contact piece 12 is supported by a driving portion 14, which is coupled to a movable plunger 13 in the electromagnet unit 7, in a movable manner in the up-and-down direction.

A spring receptacle 15, which is coupled to the driving portion 14, is arranged above the center in the long-length direction of the movable contact piece 12, a contact spring 16 is arranged between the spring receptacle 15 and a central upper portion of the movable contact piece 12, and the contact spring 16 applies predetermined downward biasing force to the movable contact piece 12.

The first fixed contact piece 10 and the second fixed contact piece 11 are conductive plates that are C-shaped in side view, and are formed integrally with the insulating substrate 3 in such a manner as to be separated from each other on both end sides in the longitudinal direction of the movable contact piece 12.

The first fixed contact piece 10 is arranged on one end side in the longitudinal direction and the first movable contact 12a side of the movable contact piece 12, and includes a first conductive plate portion 10b that faces the first movable contact 12a of the movable contact piece 12 from the lower side and has the first fixed contact 10a formed on the upper surface, a second conductive plate portion 10c that is bent from an edge of the first conductive plate portion 10b separated from the movable contact piece 12 and extends upward, and a third conductive plate portion 10d that is bent from the upper edge of the second conductive plate portion 10c and extends above the movable contact piece 12.

With the insulating substrate 3, a portion of the second conductive plate portion 10c of the first fixed contact piece 10 and a bolt head 17a of a terminal bolt 17, which is screw-fitted into the third conductive plate portion 10d, are integrally formed and a plate-shaped insulating cover portion 18 that extends between the second conductive plate portion 10c and the movable contact piece 12 in such a manner as to cover an inner side surface of the second conductive plate portion 10c facing the movable contact piece 12 is also integrally formed.

The second fixed contact piece 11 is also arranged on the other end side in the longitudinal direction and the second movable contact 12b side of the movable contact piece 12, and includes a first conductive plate portion 11b that faces the second movable contact 12b of the movable contact piece 12 from the lower side and has the second fixed contact 11a formed on the upper surface, a second conductive plate portion 11c that is bent from an edge of the first conductive plate portion 11b separated from the movable contact piece 12 and extends upward, and a third conductive plate portion 11d that is bent from the upper edge of the second conductive plate portion 11c and extends above the movable contact piece 12.

With the insulating substrate 3, a portion of the second conductive plate portion 11c of the second fixed contact piece 11 and a bolt head 19a of a terminal bolt 19 are also integrally formed and a plate-shaped insulating cover portion 20 that extends between the second conductive plate portion 11c and the movable contact piece 12 in such a manner as to cover an inner side surface of the second conductive plate portion 11c facing the movable contact piece 12 is also integrally formed.

When the movable contact piece 12 is in a released state, the movable contact piece 12 is brought into a state in which the movable contacts 12a and 12b, which are positioned on both end sides in the longitudinal direction, and the fixed contacts 10a and 11a of the first and second fixed contact pieces 10 and 11 are separated from each other with a predetermined gap maintained therebetween, respectively

In addition, the movable contact piece 12 is set in such a way that, when the movable contact piece 12 is at a turn-on position, the movable contacts 12a and 12b come into contact with the fixed contacts 10a and 11a of the first and second fixed contact pieces 10 and 11, respectively, with a predetermined contact pressure exerted by the contact spring 16.

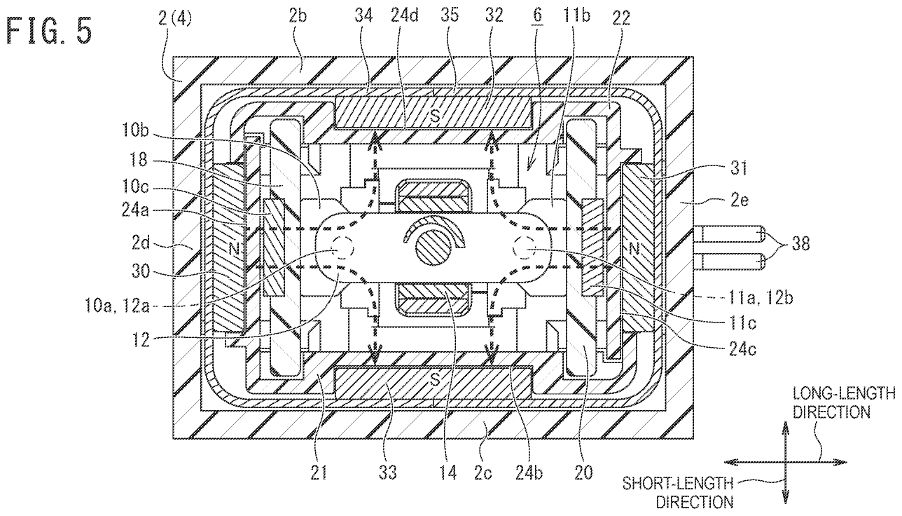

In addition, as illustrated in FIG. 5, magnet holders 21 and 22, which are formed of synthetic resin, are arranged in the contact housing portion 6, and the magnet holders 21 and 22 are supported by upper flange portions 36b of the electromagnet unit 7, which will be described later.

On the magnet holders 21 and 22, first to fourth arc-extinguishing permanent magnets 30 to 33 are arranged and permanent magnet yokes 34 and 35, which surround the outer peripheries of the first to fourth arc-extinguishing permanent magnets 30 to 33, are also arranged.

The first arc-extinguishing permanent magnet 30 is arranged in such a manner as to face one side surface in the longitudinal direction of the movable contact piece 12 via the magnet holder 21, and the second arc-extinguishing permanent magnet 31 is arranged in such a manner as to face the other side surface in the longitudinal direction of the movable contact piece 12 via the magnet holder 22. The first and second arc-extinguishing permanent magnets 30 and 31 are magnetized in such a manner that magnetic pole surfaces that face the movable contact piece 12 are magnetized to the N-pole.

The third arc-extinguishing permanent magnet 32 is arranged in such a manner as to face one side surface in the short-length direction of the movable contact piece 12 via the magnet holder 22, and the fourth arc-extinguishing permanent magnet 33 is arranged in such a manner as to face the other side surface in the short-length direction of the movable contact piece 12 via the magnet holder 21. The third and fourth arc-extinguishing permanent magnets 32 and 33 are magnetized in such a manner that magnetic pole surfaces that face the movable contact piece 12 are magnetized to the S-pole.

Because of this configuration, magnetic flux that starts from the N-pole of the first arc-extinguishing permanent magnet 30 and flows to the S-poles of the third arc-extinguishing permanent magnet 32 and the fourth arc-extinguishing permanent magnet 33 passes a vicinity of a portion at which the first fixed contact 10a of the first fixed contact piece 10 and the first movable contact 12a of the movable contact piece 12 face each other and crosses the portion with large magnetic flux density.

In addition, magnetic flux that starts from the N-pole of the second arc-extinguishing permanent magnet 31 and flows to the S-poles of the third arc-extinguishing permanent magnet 32 and the fourth arc-extinguishing permanent magnet 33 passes a vicinity of a portion at which the second fixed contact 11a of the second fixed contact piece 11 and the second movable contact 12b of the movable contact piece 12 face each other and crosses the portion with large magnetic flux density.

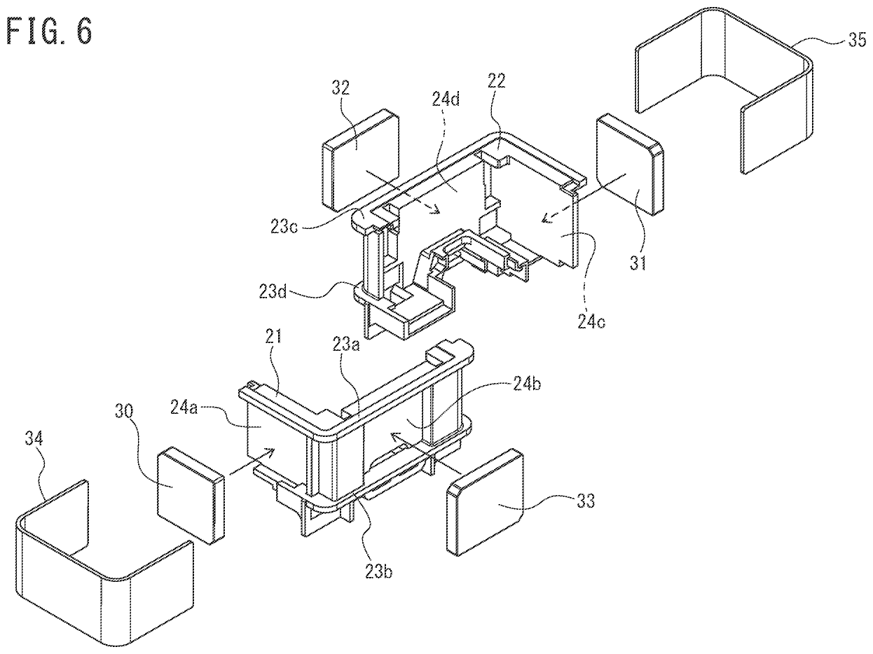

FIG. 6 is a diagram illustrative of a specific configuration of the afore-described magnet holders 21 and 22 and permanent magnet yokes 34 and 35.

The magnet holders 21 and 22 have shapes into which a rectangular cylindrical body is halved in substantially L-shapes, and one magnet holder 21 has a first magnet housing recessed portion 24a and a fourth magnet housing recessed portion 24b formed on outer surfaces between a pair of engaging pieces 23a and 23b, which protrude outward in parallel with each other. In addition, the other magnet holder 22 also has a second magnet housing recessed portion 24c and a third magnet housing recessed portion 24d formed on outer surfaces between a pair of engaging pieces 23c and 23d, which protrude outward in parallel with each other.

The first arc-extinguishing permanent magnet 30 and the fourth arc-extinguishing permanent magnet 33 are fitted into the first magnet housing recessed portion 24a and the fourth magnet housing recessed portion 24b of the one magnet holder 21, respectively. In addition, the second arc-extinguishing permanent magnet 31 and the third arc-extinguishing permanent magnet 32 are fitted into the second magnet housing recessed portion 24c and the third magnet housing recessed portion 24d of the other magnet holder 22, respectively.

The magnet holders 21 and 22, on which the first to fourth arc-extinguishing permanent magnets 30 to 33 are mounted, are combined in such a way as to form a rectangular cylindrical body.

The permanent magnet yokes 34 and 35, on the other hand, are metal plate materials each of which is bent in a substantially U shape, and are arranged on the outer periphery of the pair of magnet holders 21 and 22, which is combined into a rectangular cylindrical body, while surrounding the outer peripheries of the first to fourth arc-extinguishing permanent magnets 30 to 33, by engaging both end portions in a width direction of the permanent magnet yokes 34 and 35 with the pair of engaging pieces 23a and 23b and the pair of engaging pieces 23c and 23d of the pair of magnet holders 21 and 22.

On the other hand, the electromagnet unit 7, which is housed in the electromagnet housing portion 8 of the housing case 4, has a spool 36 arranged therein, as illustrated in FIG. 3. The spool 36 includes a central cylindrical portion 36a into which the afore-described movable plunger 13 is inserted in a vertically slidable manner, an upper flange portion 36b that projects radially outward from the upper edge of the central cylindrical portion 36a, a lower flange portion 36c that projects radially outward from the lower edge of the central cylindrical portion 36a, and a skirt portion 36d that extends from the outer peripheral edge of the lower flange portion 36c in a direction separating from the central cylindrical portion 36a. In a coil housing space formed by the central cylindrical portion 36a, the upper flange portion 36b, and the lower flange portion 36c, an excitation coil 37 is wound, and it is configured such that direct current is applied to the excitation coil 37 from a power source (not illustrated) connected to coil terminals 38.

On the outer periphery of the spool 36, a pair of magnetic yokes 39a and 39b, which are formed in C-shapes in side view, are arranged in the short-length direction, and upper edge-side yokes and lower edge-side yokes of the magnetic yokes 39a and 39b are supported by the upper flange portion 36b and the skirt portion 36d, respectively.

As illustrated in FIG. 3, to an upper portion of the solid cylindrically shaped movable plunger 13, a pair of plate-shaped elastic members 40a and 40b are fixed, in such a manner as to be separated outward in the long-length direction from each other and extend obliquely upward. To a position lower than the pair of elastic members 40a and 40b of the movable plunger 13, a plunger downward movement restricting portion 41, which projects radially outward, is fixed. To a lower portion of the movable plunger 13, a plunger upward movement restricting portion 42, which projects radially outward, is fixed.

In addition, as illustrated in FIG. 3, on a lower portion of the driving portion 14, a pair of driving portion-side engaging portions 43a and 43b, which extend inward in the long-length direction from both edges in the long-length direction, are formed. By the tip sides of the pair of elastic members 40a and 40b of the movable plunger 13 mounting on and engaging with the upper surfaces of the pair of driving portion-side engaging portions 43a and 43b, the driving portion 14 and the movable plunger 13 are coupled via the pair of elastic members 40a and 40b.

As illustrated in FIG. 3, a spring guide 44 is arranged at a lowermost portion of the electromagnet housing portion 8 (on the bottom wall 2h), and a return spring 45 is arranged between the bottom wall 2h and the movable plunger 13 while being supported by the spring guide 44.

The contact housing portion 6 and the electromagnet housing portion are filled with one or a plurality of types of arc-extinguishing gas, such as hydrogen and nitrogen, from a gas injection portion 46, which is formed in the bottom wall 2h of the housing case 4.

Next, operation of the electromagnetic contactor 1 of the present embodiment will be described.

It is assumed that, in the electromagnetic contactor 1 of the present embodiment, the negative pole (−) is connected to the first fixed contact piece 10 and the terminal bolt 17 and the positive pole (+) is connected to the second fixed contact piece 11 and the terminal bolt 19.

It is also assumed that the electromagnetic contactor 1 is in a released state in which the excitation coil 37 of the electromagnet unit 7 is in a non-excited state and the electromagnet unit 7 does not generate excitation force to cause the movable plunger 13 to descend.

In the released state, the movable plunger 13 is biased upward by the return spring 45. Thus, the plunger downward movement restricting portion 41 of the movable plunger 13 comes into contact with the driving portion-side engaging portions 43a and 43b of the driving portion 14 and upward movement of the driving portion 14 is thereby restricted, and the first movable contact 12a and the second movable contact 12b of the movable contact piece 12 of the contact mechanism 5 are separated upward from the first fixed contact 10a of the first fixed contact piece 10 and the second fixed contact 11a of the second fixed contact piece 11 by a predetermined distance, respectively. Therefore, a current path between the first fixed contact piece 10 and the second fixed contact piece 11 is in a cut-off state, and the contact mechanism 5 is in an open contact state.

When current is applied to the excitation coil 37 of the electromagnet unit 7 while the electromagnetic contactor 1 is in the released state, excitation force is generated in the electromagnet unit 7 and pushes down the movable plunger 13 downward against the biasing force of the return spring 45. The lower surface of the plunger downward movement restricting portion 41 coming into contact with the upper flange portion 36b of the spool 36 causes the descent of the movable plunger 13 to come to a stop.

The descent of the movable plunger 13 as described above causes the movable contact piece 12, which is supported by the driving portion 14 connected to the movable plunger 13 via the elastic members 40a and 40b and the driving portion-side engaging portions 43a and 43b, to also descend, and the first movable contact 12a and the second movable contact 12b of the movable contact piece 12 of the contact mechanism 5 come into contact with the first fixed contact 10a of the first fixed contact piece 10 and the second fixed contact 11a of the second fixed contact piece 11, respectively, with the contact pressure of the contact spring 16.

Therefore, the contact mechanism 5 is brought to a closed contact state in which large current from a power supply source is supplied to a load device through the first fixed contact piece 10, the movable contact piece 12, and the second fixed contact piece 11.

When the power supply to the load device is to be cut off while the contact mechanism 5 is in the closed contact state, excitation of the excitation coil 37 of the electromagnet unit 7 is stopped.

When the excitation of the excitation coil 37 is stopped, excitation force causing the movable plunger 13 to move downward by the electromagnet unit 7 disappears, and thus the movable plunger 13 ascends by biasing force of the return spring 45.

The ascent of the movable plunger 13 causes the movable contact piece 12, which is supported by the driving portion 14, to ascend, and the contact mechanism 5 is brought to an open contact start state in which the movable contact piece 12 is separated upward from the first fixed contact piece 10 and the second fixed contact piece 11.

When the contact mechanism 5 is in the open contact start state as described above, an arc is generated between the first movable contact 12a of the movable contact piece 12 and the first fixed contact 10a of the first fixed contact piece 10. In addition, an arc is also generated between the second movable contact 12b of the movable contact piece 12 and the first second contact 11a of the second fixed contact piece 11. The arcs causes the current carrying state to continue. On this occasion, a current direction of the arc generated between the first movable contact 12a and the first fixed contact 10a is a direction pointing from the first movable contact 12a to the first fixed contact 10a, and a current direction of the arc generated between the second fixed contact 11a and the second movable contact 12b is a direction pointing from the second fixed contact 11a to the second movable contact 12b.

As illustrated in FIG. 5, magnetic flux that starts from the N-pole of the first arc-extinguishing permanent magnet 30 and flows to the S-pole of the third arc-extinguishing permanent magnet 32 and magnetic flux that starts from the N-pole of the first arc-extinguishing permanent magnet 30 and flows to the S-pole of the fourth arc-extinguishing permanent magnet 33 pass a vicinity of an arc. Lorentz force pointing in the short-length direction is generated in accordance with Fleming's left hand rule, based on a relationship between flow of current of the arc generated between the first movable contact 12a and the first fixed contact 10a and the magnetic flux, and the arc generated between the first fixed contact 10a and the first movable contact 12a is not only stretched by the Lorentz force but also cooled by the arc-extinguishing gas in the contact housing portion 6 and is thereby extinguished.

In addition, when an arc is generated between the second movable contact 12b of the movable contact piece 12 and the second fixed contact 11a of the second fixed contact piece 11, Lorentz force pointing in the short-length direction is generated in accordance with Fleming's left hand rule, based on a relationship between flow of current of the arc generated between the second movable contact 12b and the second fixed contact 11a and magnetic flux generated among the second arc-extinguishing permanent magnet 31, the third arc-extinguishing permanent magnet 32, and the fourth arc-extinguishing permanent magnet 33, and the arc is not only stretched by the Lorentz force but also cooled by the arc-extinguishing gas in the contact housing portion 6 and is thereby extinguished.

Next, advantageous effects of the present embodiment will be described.

Since the housing case 4 (the insulating box 2 and the insulating substrate 3) of the present embodiment houses the pair of fixed contact pieces 10 and 11, the movable contact piece 12, and the electromagnet unit 7 in the same space and, because of this configuration, internal volume allowed for filling of arc-extinguishing gas is substantially greater, the allowable amount of leakage is smaller, and internal pressure and temperature in the contact housing portion 6 at the time of arc generation are more unlikely to increase than those of a housing container of a conventional device, which houses only a contact mechanism, it is possible to improve breaking performance of the electromagnetic contactor 1.

In addition, since the first to fourth arc-extinguishing permanent magnets 30 to 33 are arranged in the contact housing portion 6 and, because of this configuration, distance between the first to fourth arc-extinguishing permanent magnets 30 to 33 and arc generation positions (positions of the fixed contacts 10a and 11a and the movable contacts 12a and 12b) does not become long even when the internal volume of the contact housing portion 6 is increased, strong magnetic flux of the first and second arc-extinguishing permanent magnets 30 and 31 crossing the arcs causes Lorentz force to be exerted on the arcs in accordance with Fleming's left hand rule and the arcs to be surely stretched, and the arcs is cooled by the arc-extinguishing gas and is thereby extinguished, it is possible to improve breaking performance of the electromagnetic contactor 1.

In addition, since the first to fourth arc-extinguishing permanent magnets 30 to 33 are mounted on the first to fourth magnet housing recessed portions 24a to 24d that are formed on the outer surfaces of the magnet holders 21 and 22 arranged in the contact housing portion 6 of the housing case 4, it is possible to secure insulation against an arc.

Further, since the housing case 4 is formed of synthetic resin, it is possible to not only achieve substantial weight reduction but also achieve reduction in manufacturing cost, compared with an electromagnetic contactor including a case made of ceramic like a conventional device.

Further still, since the housing case 4 is coated with laminated films LF, which are laminated films of clay crystals, it is possible to suppress permeation of gas molecules, such as hydrogen and nitrogen, and thereby prevent leakage of arc-extinguishing gas, with which the housing case 4 is filled.

### REFERENCE SIGNS LIST

1 Electromagnetic contactor

2 Insulating box

2b to 2e First to fourth sidewalls

2f Fifth sidewall

2g Sixth sidewall

2h Bottom wall

2i Connection protruding line

3 Insulating substrate

3a Connection recessed line

4 Housing case (hermetically sealed container)

5 Contact mechanism

6 Contact housing portion

7 Electromagnet unit

8 Electromagnet housing portion

10 First fixed contact piece

10a First fixed contact

10b First conductive plate portion

10c Second conductive plate portion

10d Third conductive plate portion

11 Second fixed contact piece

11a Second fixed contact

11b First conductive plate portion

11c Second conductive plate portion

11d Third conductive plate portion

12 Movable contact piece

12a First movable contact

12b Second movable contact

13 Movable plunger

14 Driving portion

15 Spring receptacle

16 Contact spring

17, 19 Terminal bolt

17a, 19a Bolt head

18, 20 Insulating cover portion

21, 22 Magnet holder

23a, 23b, 23c, 23d Engaging piece

24a to 24d First to fourth magnet housing recessed portions

30 to 33 First to fourth arc-extinguishing permanent magnets

34, 35 Permanent magnet yoke

36 Spool

36a Central cylindrical portion

36b Upper flange portion

36c Lower flange portion

36d Skirt portion

37 Excitation coil

38 Coil terminal

39a, 39b Magnetic yoke

40a, 40b Elastic member

41 Plunger downward movement restricting portion

42 Plunger upward movement restricting portion

43a, 43b Driving portion-side engaging portion

44 Spring guide

45 Return spring

46 Gas injection portion

LF Laminated film (laminated film of clay crystals)

OB Organic binder

1. A hermetically sealed electromagnetic contactor comprising:
a pair of fixed contact pieces having fixed contacts;
a movable contact piece having a pair of movable contacts capable of coming into contact with and being separated from the fixed contacts of the pair of fixed contact pieces;
an electromagnet unit configured to drive the movable contact piece;
a hermetically sealed container configured to house the pair of fixed contact pieces, the movable contact piece, and the electromagnet unit in a same space in a hermetically sealed manner and being filled with arc-extinguishing gas; and
at least a pair of arc-extinguishing permanent magnets arranged inside the hermetically sealed container and configured to stretch arcs generated between the fixed contacts of the pair of fixed contact pieces and the pair of movable contacts of the movable contact piece.

2. The hermetically sealed electromagnetic contactor according to claim 1, wherein a magnet holder made of insulating material and surrounding the pair of fixed contact pieces and the movable contact piece is arranged inside the hermetically sealed container and the arc-extinguishing permanent magnets are mounted on an outer surface of the magnet holder.

3. The hermetically sealed electromagnetic contactor according to claim 2, wherein the magnet holder has a shape into which a rectangular cylindrical body is halved in substantially L-shapes.

4. The hermetically sealed electromagnetic contactor according to claim 2, wherein the magnet holder has an engaging piece protruding outward and the arc-extinguishing permanent magnets are supported by the engaging piece.

5. The hermetically sealed electromagnetic contactor according to claim 2, wherein the magnet holder is made of synthetic resin.

6. The hermetically sealed electromagnetic contactor according to claim 2, wherein a permanent magnet yoke is mounted inside the hermetically sealed container in such a manner as to surround the outer surface of the magnet holder on which the arc-extinguishing permanent magnets are mounted.

7. The hermetically sealed electromagnetic contactor according to claim 6, wherein the permanent magnet yoke has a shape into which a rectangular cylindrical body is halved in substantially U-shapes.

8. The hermetically sealed electromagnetic contactor according to claim 1, wherein the hermetically sealed container is a container made of synthetic resin.

9. The hermetically sealed electromagnetic contactor according to claim 8, wherein gas barrier coating is applied to the hermetically sealed container, using laminated films of clay crystals.

10. The hermetically sealed electromagnetic contactor according to claim 3, wherein the magnet holder has an engaging piece protruding outward and the arc-extinguishing permanent magnets are supported by the engaging piece.

11. The hermetically sealed electromagnetic contactor according to claim 3, wherein the magnet holder is made of synthetic resin.

12. The hermetically sealed electromagnetic contactor according to claim 4, wherein the magnet holder is made of synthetic resin.

13. The hermetically sealed electromagnetic contactor according to claim 3, wherein a permanent magnet yoke is mounted inside the hermetically sealed container in such a manner as to surround the outer surface of the magnet holder on which the arc-extinguishing permanent magnets are mounted.

14. The hermetically sealed electromagnetic contactor according to claim 4, wherein a permanent magnet yoke is mounted inside the hermetically sealed container in such a manner as to surround the outer surface of the magnet holder on which the arc-extinguishing permanent magnets are mounted.

15. The hermetically sealed electromagnetic contactor according to claim 5, wherein a permanent magnet yoke is mounted inside the hermetically sealed container in such a manner as to surround the outer surface of the magnet holder on which the arc-extinguishing permanent magnets are mounted.

16. The hermetically sealed electromagnetic contactor according to any one of claim 2, wherein the hermetically sealed container is a container made of synthetic resin.

17. The hermetically sealed electromagnetic contactor according to any one of claim 3, wherein the hermetically sealed container is a container made of synthetic resin.

18. The hermetically sealed electromagnetic contactor according to any one of claim 4, wherein the hermetically sealed container is a container made of synthetic resin.

19. The hermetically sealed electromagnetic contactor according to any one of claim 5, wherein the hermetically sealed container is a container made of synthetic resin.

20. The hermetically sealed electromagnetic contactor according to any one of claim 6, wherein the hermetically sealed container is a container made of synthetic resin.
